(19) United States
(12) Patent Application Publication
(10) Pub. No.: US 2008/0202034 A1
(43) Pub. Date: Aug. 28, 2008

(54) DOOR JAMB LOCKING PLATE ASSEMBLY

(76) Inventor: John Campbell, Starkville, MS (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/678,659

(22) Filed: Feb. 26, 2007

(51) Int. Cl. E06B 1/52; E05B 15/02; E05B 17/00

(52) U.S. Cl. 49/504; 292/340; 292/346

(57) ABSTRACT

A system for reinforcing the security of a locked door and door jamb combination which includes a first L-shaped plate secured to the studs of the wall adjacent the door jamb, with the L extending into the space between the studs and the door jamb; a second L-shaped plate secured to the inner face of the door jamb, including two members extending into the space between the studs and the door jamb, and one member positioned adjacent the L of the first plate; the two plates firmly secured to the door jamb and the studs, so that when force is applied to the door jamb, the plates overlap to provide a very secure relationship between the door, the door jamb and the underlying studs adjacent the door jamb virtually incapable of being compromised by an intruder. There would be provided a second assembly on the opening edge of the door and the header of the doorway to provide maximum security.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to doors and door jamb plates. More particularly, the present invention relates to an improved door jamb plate assembly which when installed provides sufficient strength to the door and door jamb on both the opening edge and the hinged edge of the door so that to make it virtually impossible to break through the locked door.

2. General Background

In the construction industry, one of the more common concerns of a builder is to assure that the structure is constructed so that an intruder is prevented from entering a locked opening, such as an exterior door. It is common knowledge that although one may provide a plurality of locking mechanisms in an attempt to prevent a forced entry, the locking mechanisms are only as strong as the framework onto which they are fastened. It is often the case that in a forced entry, the locking mechanism itself remains in tact, but the entire door frame or door jamb is pulled from its mounting rather than the door being forced open by breaking the locks themselves.

Such an event is being addressed constantly, but until now, no satisfactory solution to avoiding a door jamb from being dismounted during a forced entry has been developed. However, the present invention provides a very strong system, when installed in a doorway, which prevents the destruction of the door jamb by a forced entry. In effect, it provides a door and door jamb combination, so that when the door is locked, one is virtually unable to compromise the door and door jamb, and unable to break through the doorway.

### SUMMARY OF THE PRESENT INVENTION

The system of the present invention solves the problems in the art in a simple and straightforward manner. What is provided is a system for reinforcing the security of a locked door and door jamb combination which includes a first L-shaped plate secured to the studs of the wall adjacent the door jamb of the hinged edge of the door, with the L extending into the space between the studs and the door jamb; a second L-shaped plate secured to the inner face of the door jamb, including two members extending into the space between the studs and the door jamb, and one member positioned adjacent the L of the first plate; the two plates firmly secured to the door jamb and the studs, so that when force is applied to the door jamb, the plates overlap to provide a very secure relationship between the door, the door jamb and the underlying studs adjacent the door jamb virtually incapable of being compromised by an intruder. There would be provided a second assembly on the opening edge of the door and the header of the doorway to provide maximum security.

Therefore, it is a principal object of the present invention to provide an interlocking system between the door jamb and studs of the wall to provide a secure and impenetrable security against an intruder;

It is a further principal object of the present invention to provide a security system for an exterior door which may be retrofitted to doorways, or may be built into the doorway during construction so as to provide a strong and secure doorway assemblage which protects against unwanted intrusion.

It is a further object of the present invention to provide system mounted between the door jamb and underlying studs around the door jamb so that reinforcement plates interrelate to warrant off damage of the doorway by an intruder.

It is a further object of the present invention to provide the system as described on both the opening edge, the hinged edge and the header portion of a door, for providing maximum protection against the door being compromised by forced entry.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 illustrates a top view of the security system installed on the door jamb adjacent the hinged edge of an exterior door;

FIG. 2 illustrates the view in FIG. 1, with the exterior door moving to the open position;

FIG. 3 illustrates a top view of the security system installed on the door jamb which accommodates the opening edge of the exterior door;

FIG. 4 illustrates the view of the security system installed on the door header of the exterior door;

FIG. 5 illustrates a front view of the security plate mounted to the door jamb;

FIG. 6 illustrates a cross section view of the plate illustrated in FIG. 5;

FIG. 7 illustrates side view of the plate illustrated in FIG. 6 of the present invention; and

FIG. 8 illustrates a rear view of the plate illustrated in FIG. 6 of the present invention.

### DETAILED DESCRIPTION OF THE PREFERRED EMBODIMENT

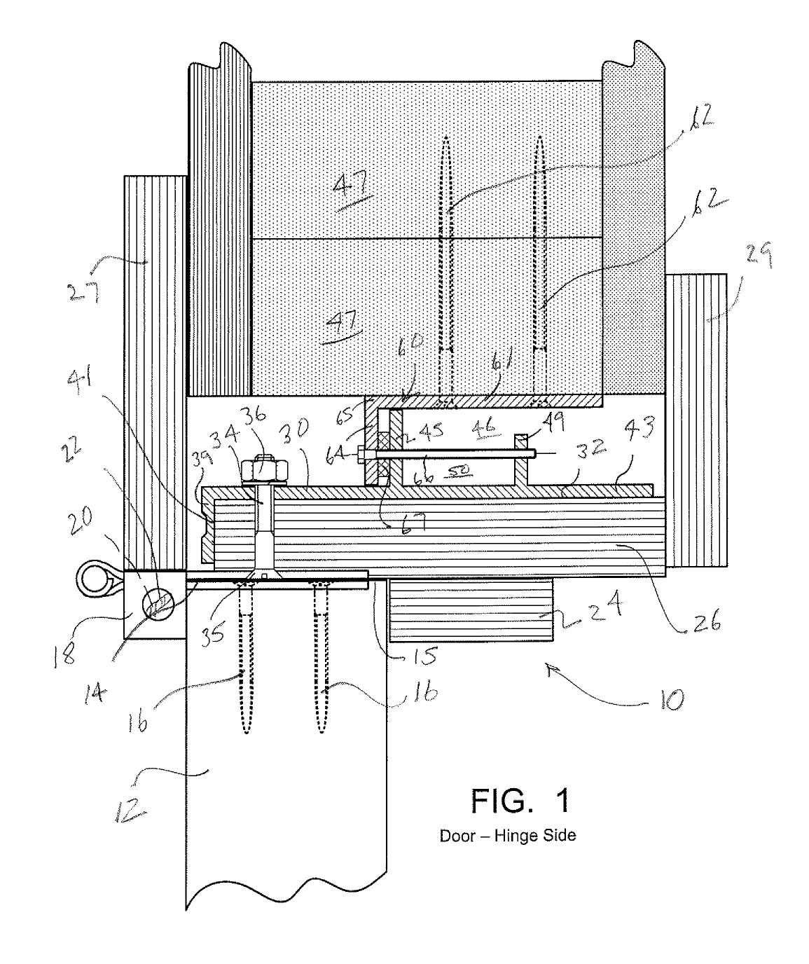

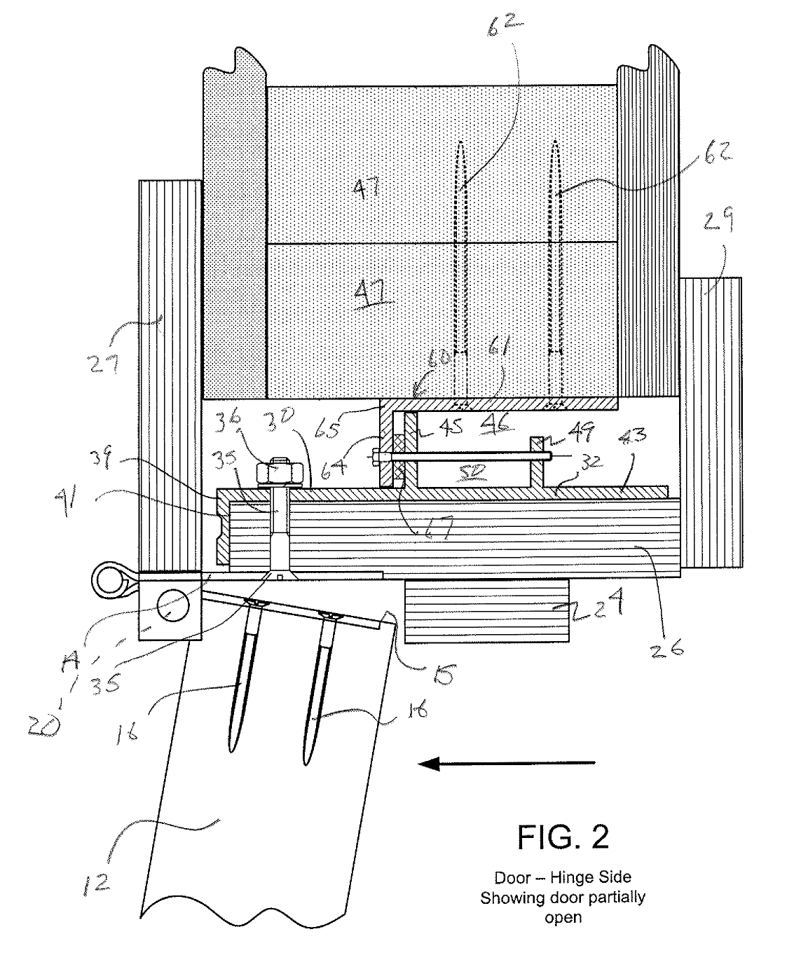

FIGS. 1 through 8 illustrate the preferred embodiment of the exterior door security system of the present invention by the numeral 10. As illustrated first in FIGS. 1 and 2, the system 10 is seen installed on a door and door jamb with the door closed in FIG. 1 and slightly ajar in FIG. 2. First there is illustrated the door 12 secured to a hinge 14 by screws 16; and as is conventional, door 12 would be secured with either three of four hinges 14 along its edge 15. For purposes of this discussion, the hinge 14 may be a conventional hinge 14, or may be, as illustrated a new and inventive hinge, having a locking feature, a pair of plates 18 secured to the upper and lower edge of each hinge 14, each plate having an opening 20 through which a metal pin 22 would be positioned, so when the door 12 is closed, and the pin 22 in place, the door could not be opened, since the pin 22 would render the hinge 14 inoperable. This inventive hinge is the subject of a patent application currently pending by the same inventor, entitled “Locking Mechanism for Door Hinge”, and which is incorporated herein by reference thereto.

Returning to the present invention, as seen, the door 12 in FIGS. 1 and 2 is positioned between its hinge mount and the door stop 24 which is mounted to the door jamb 26. There is seen exterior trim 27 and interior trim 29. This is a conventional mount. However, as seen, there is a first plate 30 secured to the inner face 32 of the door jamb 26, via a bolt 34 secured through the door jamb 26, and through the plate 30, with a nut 36 maintaining the plate 30 bolted securely against the inner face 32 of jamb 26. It should be noted that the head 35 of bolt 34 lies beneath hinge plate 14. The plate 30 includes a first L member 39 which extends against the exterior edge 41 of door jamb 26, with the long side 43 of the plate extending along substantially the entire width of jamb 26. The plate 30, as it extends long the jamb 26 includes a first extension 45, extending into the space 46 between the jamb 26 and the studs 47 adjacent the jamb 26. There is then provided a second extension 49 from the long side 43 of plate 30, along its length, defining a space 50 between the first and second extensions 45, 49, the function of which will be described further.

Turning still to FIGS. 1 and 2, there is seen a second plate 60 which is secured to the face of the stud 47 facing space 46, the long side 61 of plate 60 secured to the stud with a pair of wood screws 62 engaged securely into both studs 47 as seen. The second plate 60 likewise includes an L member 64 extending from the end 65 of plate 60, with L member 64 extending into space 46, and as seen positioned very close to the first extension 45 of plate 30. There is positioned a compressible member 67 of rubber or the like, which will function as to be described. There is provided a threaded pin 66 extending through the L member 64 of plate 60, and the two extensions 45, 49, and through the compressible member 67.

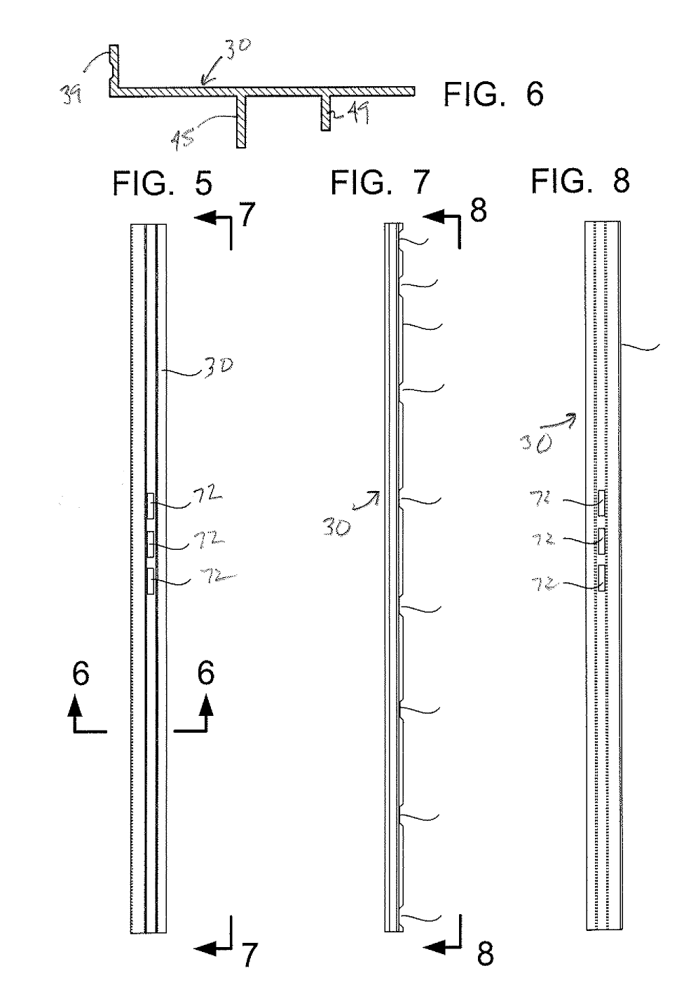

Before discussing the operation of the assembly 10, reference is again made to FIG. 1, which shows assembly 10 as described in place. Again, it should be noted that this assembly 10 as fully illustrated in FIGS. 5 through 8 may extend through the entire length of the door jamb 26 or may be placed along strategic points along the length of the door jamb 26.

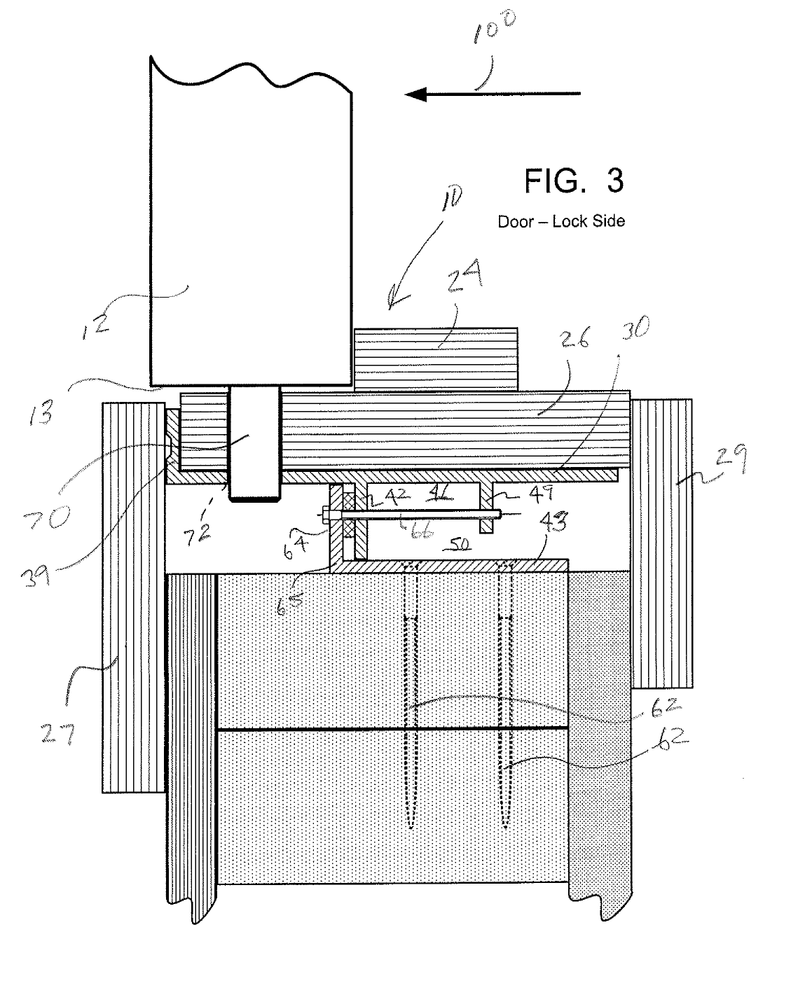

Reference is now made to FIG. 3, where the same system is seen secured to the door jamb 26 positioned along the locking edge 13 of the door 12. As seen again, the door 12 is seen with the locking bolt 70 extending into the door jamb 26 as is a very conventional manner. However, there is provided the locking system 10, of the identical type as was described in FIGS. 1 and 2, the only difference being that the system in FIG. 3 is secured to the door jamb 26 on the locking edge 13, and therefore the components will not be described, since they are essentially what is seen in FIGS. 1 and 2, except the changes to accommodate the locking bolt 70. Also the first plate 30 which is secured to the door jamb would be secured in the same fashion, but would have an opening 72 to accommodate the entry of the bolt 70 therethrough when the door is locked as illustrated.

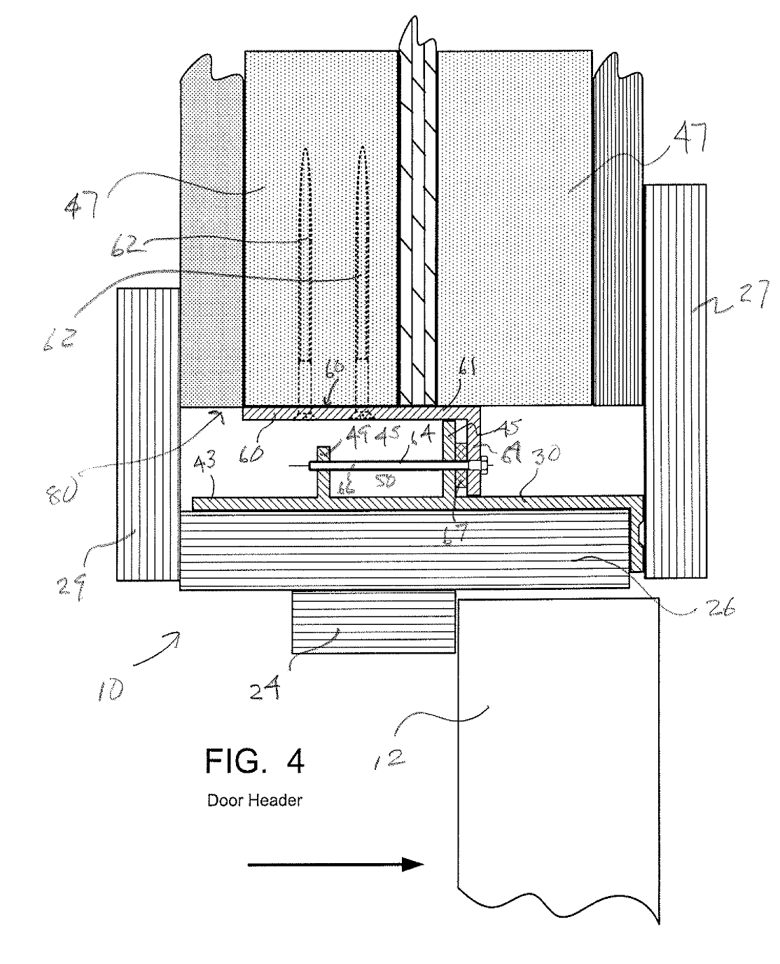

FIG. 4 illustrates the locking system 10 secured to the door header 80, again with the plates 30 and 60 secured to the door jamb plate 26 and the studs 45, as was done in FIGS. 1 through 3, so that, as will be described below, when the system 10 is in place, it is in place long both vertical edges of the door 12, and along the upper header portion for a very secure doorway.

In operation, after the system has been installed as described above, what will be described are the dynamics which take place when an intruder attempts to compromise the doorway, through door 12. Since exterior doors open to the inside, as seen in FIGS. 2 and 3, the intruder will be placing force in the direction arrow 100. When the force is applied, first, the lock bolt 70 will not only be engaged in the opening in door jamb 26, but it will also be engaged in the opening 72 in the plate 30, which is bolted into the door jamb via bolt 70 as described in FIG. 1. In addition, should the door jamb 26 appear to be compromised, the first member 45 will be forced against the member 64 of second plate 60 which is secured to the studs 45 by screws 62. This will prevent the door jamb 26 from disengaging from its position, since the two plates 30, 60 are engaged and interlocked to prevent movement. The compressible member 67 secured between the extension 45 of plate 30 and the L member 64 of plate 60, provides a slight give when the door is locked, before a greater force would have the two extensions be forced against one another.

As was described earlier, the plate 30, as illustrated in FIGS. 5 through 8 may extend along the entire side vertical edges of the doorway and along the door header 80, serving to define a virtually impenetrable door way against forced entry. Or, it could be installed in one or more points along the door edges, if one would not wish to use the entire system along both edges of the entire doorway.

All measurements disclosed herein are at standard temperature and pressure, at sea level on Earth, unless indicated otherwise.

The foregoing embodiments are presented by way of example only; the scope of the present invention is to be limited only by the following claims.

The following is a list of reference numerals:

LIST FOR REFERENCE NUMERALS

| (Reference No.) | (Description) |
|---|---|
| 10 | system |
| 12 | door |
| 13 | locking edge |
| 14 | hinge |
| 16 | screws |
| 18 | plates |
| 20 | opening |
| 22 | metal pin |
| 24 | door stop |
| 26 | door jamb |
| 27 | interior trim |
| 29 | exterior trim |
| 30 | first plate |
| 32 | inner face |
| 34 | bulk |
| 35 | head |
| 36 | nut |
| 39 | L member |
| 41 | exterior edge |
| 43 | long side |
| 45 | first extension |
| 46 | space |
| 47 | studs |
| 49 | second extension |
| 50 | space |
| 60 | plate |
| 61 | long side |
| 62 | wood screw |
| 64 | L member |
| 65 | end |
| 66 | threaded pin |
| 67 | compressible member |
| 70 | locking bolt |
| 72 | opening |

1. A system for securing the integrity of a doorway, comprising:
a. a door hinged to a door frame on a first edge and locked closed with a lock engaging the closed door to the door frame on a second edge;
b. a first plate boltingly secured to substantially the entire length of an inner face of a door jamb portion of the door frame on the first edge of the door;
c. a second plate boltingly secured to substantially the entire length of studs mounted adjacent the inner face of the door jamb portion of the door frame;
d. at least a first member extending inward from the first plate;
e. at least a second member extending from the second plate; and
f. the first and second members overlappingly engaged to one another, so that when force is placed on the door, the engaged overlapping members engage-and prevent the door and door jamb from moving out of their engaged position, and allow the lock engaging the closed door to the door frame to remain engaged and locked in place.

2. The system in claim 1, wherein the first and second plates extend from the uppermost to the lowermost end of the length of the doorjamb and studs.

3. The locking system in claim 1, further comprising a pin extending through the first and second overlapping members, to engage the members against one another.

4. The locking system in claim 1, wherein there is further provided a compressible member positioned between the first and second members on the first and second plates.

5. The locking system in claim 1, wherein the first and second plates would be positioned on the doorjamb adjacent a door stop and on the doorjamb on the locking edge of the door.

6. The system in claim 1, further comprising a bolt extending through the hinge, the doorjamb and the first plate, the bolt secured with a nut to provide additional strength to the first plate.

7. A system for securing the integrity of a doorway, comprising:
a. a door hinged to a door frame on a first edge and locked closed with a lock engaging the closed door to the door frame on a second edge;
b. a first plate secured to an inner face of a door jamb portion of the door frame along substantially the entire length of the second edge of the door;
c. a second plate secured to the studs adjacent an inner face of the door jamb along substantially the entire length of the second edge of the door;
d. at least a first member extending from the first plate;
e. at least a second member extending from the second plate;
f. the first and second members overlappingly engaged so that when force is placed on the door, the engaged overlapping members prevent the door and door jamb from moving out of engaged position; and
g. a compressible member positioned between the first and second overlapping members, so that when a weak force is placed upon the members the members do not engage metal against metal.

8. The system in claim 7, wherein the first plate includes an opening for accommodating a locking bolt engaged therethrough when the door is in the locked configuration.

9. The system in claim 7, wherein the compressible member is supported between the overlapping members with a threaded member engaged through the compressible members and the overlapping members.

10. A locking system for a doorway, comprising:
a. a door, having a first hinged edge for securing to a door frame, and a second closing edge for closing against the door frame;
b. a first plate secured to an inner face of a doorjamb portion of the door frame secured to the hinged edge of the door;
c. a second first plate secured to an inner face of a doorjamb portion of the door frame secured to the opening edge of the door;
d. a second plate secured to studs adjacent the inner face of the doorjamb on the hinged edge of the door;
e. an additional second plate secured to studs adjacent the inner face of the doorjamb on the opening edge of the door;
f. at least a first member extending from each of the first plates;
g. at least a second member extending from each of the second plates; and
h. the first and second members of the first and second plates overlappingly engaged and the first and second members of the second plates overlappingly engaged so that when force is placed on the door the engaged overlapping members prevent the door and door jamb from both the hinged edge of the door or the opening edge of the door from moving out of engaged position.

11. The system in claim 10, wherein the system would be installed along the door header of the door assembly.

12. The system in claim 10, wherein there is further provided a compressible member position between the first and second members on the first and second plates of both the opening edge and the hinged edge of the door.
